(19) United States
(12) Patent Application Publication
(10) Pub. No.: US 2012/0109578 A1
(43) Pub. Date: May 3, 2012

(54) TIME TRACKING SYSTEMS AND METHODS

(76) Inventors: Subir Parulekar, Santa Clara, CA (US); Sandeep Subhash Khabiya, San Jose, CA (US); Rajmohan Rajamariappan, Milpitas, CA (US)

(21) Appl. No.: 12/914,418

(22) Filed: Oct. 28, 2010

(51) Int. Cl. G04F 10/00

(52) U.S. Cl. 702/178

(57) ABSTRACT

Systems and methods are provided for time tracking. A method for time tracking can include parsing contents of an application page accessed by a user and displaying a time tracker user interface to the user responsive to detecting time tracking context information within the contents of the application page. The time tracker user interface can indicate a current item associated with the application page and against which time can be logged. The method can include logging time against the current item, adding the current item and associated logged time information to a maintained list of items against which time has been logged, and providing the items of the maintained list and associated logged time information to a time sheet application page accessed by the user.

### BACKGROUND

It is often useful to track time spent by working individuals in order to accurately bill customers/clients for work performed on particular activities (e.g., tasks, projects, meetings, etc.). Various time tracking solutions include the use of paper-based time sheets or electronic time sheets, which often can entail manual entry by a user of time spent on particular activities. As such, time tracking time can be a burdensome and inefficient process for many individuals.

### BRIEF DESCRIPTION OF THE DRAWINGS

FIG. 1 is a block diagram of an example time tracking system according to the present disclosure.

FIG. 2 illustrates an example application associated with time tracking according to the present disclosure.

FIG. 3 illustrates an example user interface associated with time tracking according to the present disclosure

FIG. 4 is a functional block diagram illustrating an example of providing logged time information to a time sheet application page according to the present disclosure.

FIG. 5 is a flow diagram illustrating an example of a method for time tracking according to the present disclosure.

### DETAILED DESCRIPTION

Embodiments of the present disclosure may include methods, systems, and machine readable and executable instructions and/or logic. An example method for time tracking can include parsing contents of an application page accessed by a user and causing a display of a time tracker user interface responsive to detecting time tracking context information within the contents. The time tracker user interface can indicate a current item associated with the application page and against which time can be logged. The method can include logging time against the current item, adding the current item and associated logged time information to a maintained list of items against which time has been logged, and providing the items of the maintained list and associated logged time information to a time sheet application page for access by the user.

Embodiments of the present disclosure can provide various benefits such as facilitating improved user experience associated with tracking time and generating time sheets as compared to previous time tracking approaches. Embodiments can also provide benefits such as reducing system load as compared to prior approaches, among other benefits

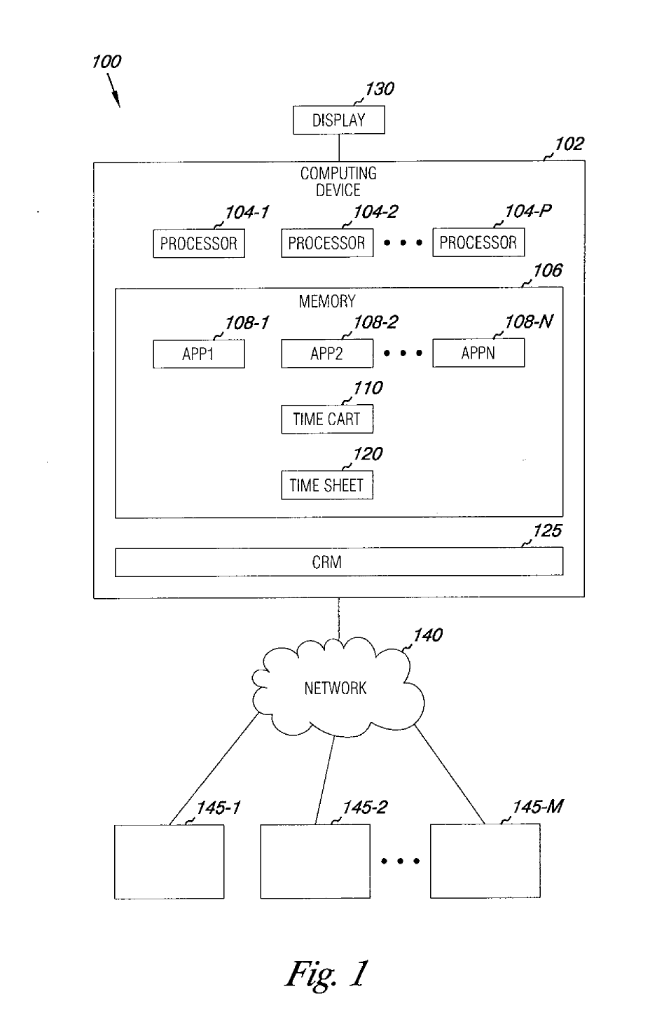

FIG. 1 is a block diagram of an example time tracking system 100 according to the present disclosure. In the example illustrated in FIG. 1, the system 100 includes a computing device 102. The computing device 102 can be a desktop computer, a laptop computer, or a mobile device such as a PDA (personal digital assistant) or a smartphone, among other electronic computing devices. The computing device 102 includes processing resources (e.g., processors 104-1, 104-2, . . . , 104-P) and memory resources 106. The memory resources 106 can include volatile and/or non-volatile memory, among other types of storage media.

In the example illustrated in FIG. 1, the memory 106 includes a number of sets of computer executable instructions stored therein that can be executed by one or more of the processors 104-1, 104-2, . . . , 104-P to perform various functions as described herein. In the example illustrated in FIG. 1, the sets of computer executable instructions 108-1 (APP1), 108-2 (APP2), 108-N (APPN) are software applications (e.g. programs). The applications 108-1, 108-2, . . . , 108-N can include word processor applications, spreadsheet applications, financial analysis applications, management applications (e.g., customer relationship management, time management, resource management, etc.), email applications, media applications (e.g., social media and/or social networking applications), web applications, and design applications, among various other computer applications.

As illustrated in FIG. 1, a time cart application 110 can be stored in the memory 106. The time cart application 110 includes computer executable instructions that can be executed by processor resources (e.g., 104-1, 104-2, . . . , 104-P) to perform time tracking in accordance with embodiments described herein. Embodiments can also include a time sheet application 120 stored in memory 106. A user of device 102 can access the time sheet application 120 to generate a time sheet corresponding to activities performed over a particular time period.

The computing device 102 can be coupled to a display component 130 (e.g., various types of monitors), as well as various other peripheral components, such as printers, facsimile devices, cameras, and/or scanners (not shown in FIG. 1), among other peripheral devices.

The computing device 102 also includes a computer readable medium (CRM) 125 in communication with the processing resources 104-1, 104-2, . . . , 104-P. The CRM 125 can be a tangible non-transitory CRM that can store computer readable instructions that can be executed to perform time tracking according to embodiments described herein. As an example, the CRM 125 can store executable instructions corresponding to an application such as time cart application 110 and/or time sheet application 120.

In various embodiments, the CRM 125 can reside in the memory 106; however, embodiments are not so limited. For instance, the CRM may reside external to computing device 102, such as within a portable memory coupled to the device 102 or within an internal memory of another computing device (e.g., a computing device such as 145-1, 145-2, . . . , 145-M coupled to the computing device 102 through a network 140, such as the Internet), in some embodiments. As used herein, the CRM 125 can include volatile memory such as dynamic access memory (DRAM) and/or non-volatile memory such as Flash memory, phase change random access memory (PCRAM), hard disks, optical discs, digital video discs (DVDs), or solid state drive (SSD), among other computer-readable storage media.

As illustrated in FIG. 1, the computing device 102 can be coupled to a number of other computing devices 145-1, 145-2, . . . , 145-M via a network 140. The network 140 can be a local area network (LAN), a wide area network (WAN), a public network (e.g., the Internet), and/or a private network (e.g., an intranet), among other network types. Although not shown in FIG. 1, the computing devices 145-1, 145-2, . . . , 145-M can include memory resources and processor resources. The devices 145-1, 145-2, . . . , 145-M can include desktop or laptop computers, mobile devices, peripheral devices, and/or servers, such as various types of application servers (e.g., web servers, email servers, database servers, etc.) having applications running thereon that can include website hosting, inventory management, email management, file management, and database management, among others.

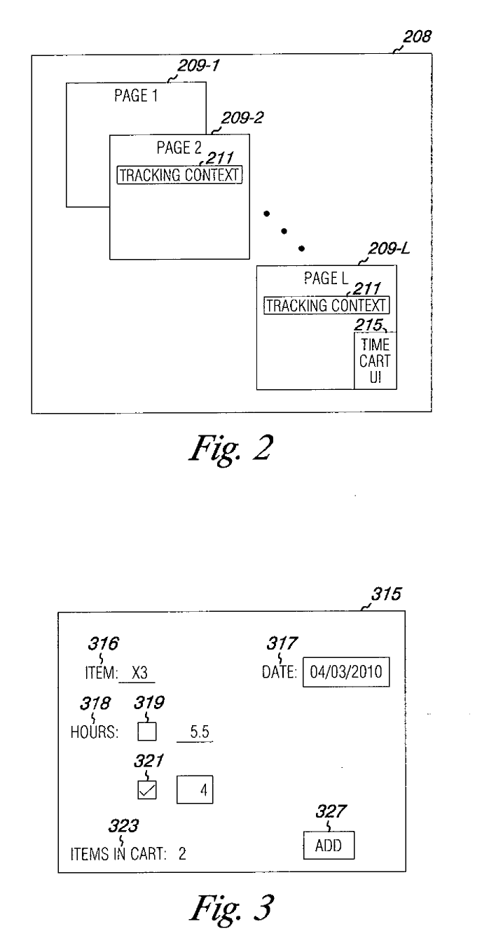

FIG. 2 illustrates an example application 208 associated with time tracking according to the present disclosure. The application 208 can be an application such as applications 108-1, 108-2, . . . , 108-N shown in FIG. 1. The application 208 can include computer executable instructions executed by processor resources to perform particular functions. As an example, executable instructions corresponding to the application 208 can be executed to provide a number of application pages (e.g., 209-1 (PAGE 1), 209-2 (PAGE 2), . . . , 209-L (PAGE L)) to a user of a computing device (e.g., to a user of a computing device such as device 102 shown in FIG. 1 via display component 130).

In various instances, it can be useful and/or desirable to track the time that a user (e.g., a business professional or other employee) spends on an activity or item associated with a particular application page 209-1, 209-2, . . . , 209-L or pages. As such, embodiments of the present disclosure can provide a user of a computing device with a way to log or record time against selected activities as the user navigates through various different applications and/or application pages.

In various embodiments, computer executable instructions associated with a time cart component (e.g., time cart application 110 shown in FIG. 1) can be executed to parse the contents of application pages (e.g., 209-1, 209-2, . . . , 209-L) accessed by a user in order to determine whether the application page is one associated with an activity or item for which the user may track his/her time, if desired. In various embodiments, tracking context information (e.g., 211) can be provided within the content of those application pages associated with an activity for which the user may track time. For instance, in the example shown in FIG. 2, the application pages 209-2 and 209-L include tracking context information 211, while the application page 209-1 does not include tracking context information.

As illustrated in FIG. 2, in various embodiments, computer executable instructions associated with the time cart component can be executed to cause a display of a time tracker user interface 215 (“TIME CART UI” as shown in FIG. 2) to a user responsive to detecting the time tracking context information 211 within the contents of the application page (e.g., 209-2 and 209-L). As such, when the user navigates to application page 209-1, which does not include the tracking context information 211 within its contents, the time tracker user interface 215 is not displayed to the user. However, when the user navigates to an application page that does include the tracking context information 211 within its contents, the time tracker user interface 215 is displayed to the user. As an example, the time tracker user interface 215 can be displayed on the same application page currently accessed (e.g., loaded) by the user. For instance, the user interface 215 may initially appear in a collapsed state or as a small icon in a corner of the application page and can be subsequently increased in size upon selection by the user (e.g., by “clicking” on the icon).

The tracking context information 215 can be, for example, provided within the application pages 209-1, 209-2, . . . , 209-L as hidden HTML (hypertext markup language) elements. However, embodiments are not limited to context Information of a particular format. In various embodiments, the tracking context information 215 can provide item description information corresponding to an activity or item associated with the particular application page 209-1, 209-2, . . . , 209-L. Computer executable instructions associated with the time cart component (e.g., time cart application 110 shown in FIG. 1) can be executed to display at least some of the item description information to the time tracker user interface 215. Such information can indicate the particular activity against which time can be logged by the user, which can allow the user to determine whether he/she wishes to log time against the particular item. Therefore, in various embodiments, the item description information can be displayed to the user prior to time being logged against the particular item.

The time tracker user interface 215 can, for example, provide various information to a user, which can facilitate time tracking in accordance with embodiments described herein. A time tracker user interface is described further below in connection with FIG. 3, which illustrates an example user interface 315 associated with time tracking according to the present disclosure. As described above, the user interface 315 can be displayed on an application page (e.g., 209-1, 209-2, . . . , 209-L) responsive to detected time tracking context information (e.g., 211) within the content of the application page.

The user interface 315 provides various information associated with time tracking in accordance with embodiments described herein. For instance, the user interface 315 displays an item descriptor 316 (e.g., X3 in this example). As described above, item description information corresponding to a particular item associated with the currently accessed application page can be provided within the tracking context information of the page and provided to the user interface 315 based thereon. In this example, the item descriptor 316 of user interface 315 indicates “X3.” As such, X3 is the item descriptor corresponding to the item/activity associated with the application page currently accessed by the user, and against which time can be logged. As such, the item descriptor 316 can refer to various particular items including a word processor document, a spreadsheet application page, an email, or a management application page, among various other items, activities, and/or tasks against which time can be logged.

The user interface 315 also includes a date field 317 (DATE), which indicates the current date (e.g., Apr. 3, 2010) on which the application page is accessed. In various embodiments, and as illustrated in FIG. 3, the user interface 315 includes a time field 318 (HOURS) and associated user selectable checkboxes 319 and 321. In this example, checkbox 319 corresponds to a number of hours logged against the current item (e.g., X3) as automatically determined by a timer component of the time cart application (e.g., time cart application 110 shown in FIG. 1). For instance, computer executable instructions associated with the time cart application can be executed to start logging time against the current item in response to the user accessing the current application page. In this example, the user interface 315 includes a data field corresponding to checkbox 319 indicating that 5.5 hours have been logged against item X3 (e.g., 5.5 hours have elapsed since the user navigated to the current application page to which item X3 corresponds). In the example shown in FIG. 3, the checkbox 321 has a corresponding data field that a user can use to manually enter a time (e.g., number of hours) to log against the current item (e.g., X3). As such, a user can select (e.g., “check”) checkbox 319 or checkbox 321. In this example, checkbox 321 is selected and the corresponding data field indicates that the user has entered “4”.

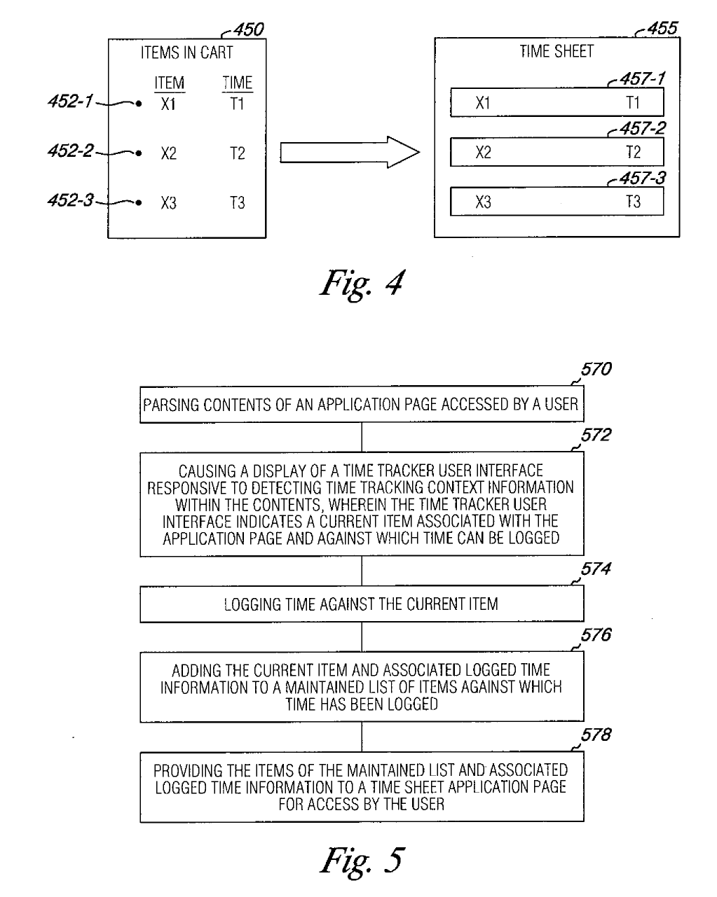

In various embodiments, computer executable instructions associated with the time cart application are executed to maintain a list of items against which time has been logged (e.g., a list of the items on which the user has spent time and for which the user desires the time to be tracked). The maintained list can be referred to herein as a “time cart” and can include the item(s) against which time has been logged as well as information associated therewith (e.g., information such as an amount of logged time associated with each of the respective items in the time cart). An example of the maintained list, or time cart, is described further below in connection with FIG. 4.

As illustrated in FIG. 3, interface 315 includes a field 323 (ITEMS IN CART) that indicates the total items currently in the time cart. In this example, field 323 indicates that 2 items are currently in the time cart. As illustrated, the user interface 315 can include a user-selectable button 327 (ADD), which a user can select in order to add the current item (e.g., X3) and associated logged time information to the time cart. For example, a user can select button 327 in order to add item X3 and its associated logged time information to the time cart. In this example, the associated logged time information would be 4 hours, since checkbox 321 is selected and “4” appears in the corresponding data field. Accordingly, when the user navigates to a subsequent application page containing time tracking context information such that the user interface 315 is displayed, the interface 315 will be updated. For instance, the fields 316, 317, 318, and 323 will reflect a current item descriptor, date, logged time, and total number of items in the time cart, respectively. That is, computer executable instructions can be executed to parse contents of a subsequent application page accessed by the user, display the time tracker user interface to the user responsive to detecting time tracking context information within the contents of the subsequent application page, and update the displayed content of the time tracker user interface. The subsequent application page accessed by the user can correspond to the same application or to a different application. That is, the subsequent application page can be a different page of the same application or an application page of a different application.

FIG. 4 is a functional block diagram illustrating an example of providing logged time information to a time sheet application page according to the present disclosure. FIG. 4 includes an example of a maintained list 450 of items against which time has been logged and associated logged time information (e.g., a time cart 450). The time cart 450 includes a number of entries 452-1, 452-2, and 452-3. However, embodiments are not limited to a particular number of entries within time cart 450. Each entry includes item descriptor information and a corresponding logged time value. For instance, entry 452-1 includes item descriptor X1 and corresponding logged time value T1, entry 452-2 includes item descriptor X2 and corresponding logged time value T2, and entry 452-3 includes item descriptor X3 and corresponding logged time value T3. The entries in the time cart 450 correspond to items added to the time cart via user interaction with a time tracking user interface such as time tracker user interface 315 described above in connection with FIG. 3.

FIG. 4 also includes a time sheet application page 455. The time sheet application page can be associated with a time sheet application such as time sheet application 120 shown in FIG. 1. As illustrated in FIG. 4, various embodiments of the present disclosure include providing the items of the maintained list 450 and associated logged time information to a time sheet application page 455 accessed by the user. As an example, the item descriptor information and corresponding logged time information associated with each of the entries 452-1, 452-2, and 452-3 can be automatically provided to the time sheet application page 455. As such, each of the entries 457-1, 457-2, and 452-7 in the time sheet 455 corresponds one of the respective entries 452-1, 452-2, and 452-3 from the time cart 450. For instance, computer executable instructions associated with the time cart application (e.g., time cart application 110 shown in FIG. 1) can be executed to automatically populate the entries 457-1, 457-2, and 452-7 of the time sheet 455 with information from the time cart 450.

In various embodiments, the contents of the time cart 450 can be displayed to the user in conjunction with generating a time sheet (e.g., time sheet 455). In some instances, the displayed time cart can include a selectable button that the user can click in order to transfer the contents of the time cart 450 to the time sheet 455. The user may also be able to select which of the entries in the time cart to transfer to the time sheet (e.g., if the user does not desire all of the entries in the time cart to be transferred to the time sheet.

FIG. 5 is a flow diagram illustrating an example of a method for time tracking according to the present disclosure. At block 570, the method includes parsing contents of an application page accessed by a user.

At block 572, the method includes causing a display of a time tracker user interface responsive to detecting time tracking context information within the contents. The time tracker user interface indicates a current item associated with the application page and against which time can be logged.

At block 574, the method includes logging time against the current item. At block 576, the method includes adding the current item and associated logged time information to a maintained list of items against which time has been logged. At block 578, the method includes providing the items of the maintained list and associated logged time information to a time sheet application page for access by the user.

As described above, embodiments of the present disclosure provide time tracking systems and methods that allow a user to track time spent on various items/activities and/or to generate time sheets in an efficient manner. Embodiments also facilitate improved user experience associated with tracking time and generating time sheets as compared to previous time tracking approaches, among other benefits.

Method embodiments of the present disclosure can be implemented via computer executable instructions in the form of software, hardware, and/or firmware, or a combination thereof. The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

Various examples of the system and method for collaborative information services have been described in detail with reference to the drawings, where like reference numerals represent like parts and assemblies throughout the several views. Reference to various examples does not limit the scope of the system and method for displaying advertisements, which is limited just by the scope of the claims attached hereto. Additionally, any examples set forth in this specification are not intended to be limiting and merely set forth some of the many possible examples for the claimed system and method for collaborative information services.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an embodiment,” as used herein does not necessarily refer to the same embodiment, although it may.

In the foregoing discussion of the present disclosure, reference is made to the accompanying drawings that form a part hereof, and in which is shown by way of illustration how examples of the disclosure may be practiced. These examples are described in sufficient detail to enable those of ordinary skill in the art to practice the embodiments of this disclosure, and it is to be understood that other examples may be utilized and that process, electrical, and/or structural changes may be made without departing from the scope of the present disclosure. As used herein, the designators “N,” “M,” “P,”, and “L” particularly with respect to reference numerals in the drawings, indicate that a number of the particular feature so designated can be included with examples of the present disclosure. The designators can represent the same or different numbers of the particular features.

The figures attempt to follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 208 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

In Detailed Description, some features are grouped together in a single embodiment for the purpose of streamlining the disclosure. This method of disclosure is not to be interpreted as reflecting an intention that the disclosed examples of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for time tracking, comprising:
parsing contents of an application page accessed by a user;
causing a display of a time tracker user interface responsive to detecting time tracking context information within the contents, wherein the time tracker user interface indicates a current item associated with the application page and against which time can be logged;
logging time against the current item;
adding the current item and associated logged time information to a maintained list of items against which time has been logged; and
providing the items of the maintained list and associated logged time information to a time sheet application page for access by the user.

2. The method of claim 1, wherein causing includes causing a display of the time tracker user interface that includes a total number of items corresponding to the maintained list of items.

3. The method of claim 1, wherein causing includes causing a display of the time tracker user interface that includes current item description information obtained from the time tracking context information prior to logging time against the current item.

4. The method of claim 1, wherein logging time against the current item includes determining a time elapsed since the application page was accessed by the user.

5. The method of claim 4, including causing an updated display of the time tracker user interface that includes the time elapsed since the application page was accessed by the user prior to adding the current item and associated logged time information to the maintained list.

6. The method of claim 4, including providing, on the displayed time tracker user interface, an option for the user to enter a time amount different from the determined time elapsed since the application page was accessed.

7. The method of claim 1, including:
parsing contents of a subsequent application page accessed by the user; and
causing the display of the time tracker user interface to the user responsive to detecting time tracking context information within the contents of the subsequent application page.

8. The method of claim 7, wherein the subsequent application page corresponds to an application which is different from an application to which the application page corresponds.

9. A non-transitory computer-readable medium having instructions stored thereon that, when executed by a processor, cause the processor to:
detect contents of an accessed application page;
cause a display of a time tracker user interface responsive to detection of time tracking context information within the contents of the application page, wherein the time tracker user interface indicates a current item associated with the application page and against which time can be logged;
maintain a list of items against which time has been logged along with corresponding recorded time information;
record time against the current item;
provide the current item and associated recorded time information to the maintained list; and
provide the items of the maintained list and associated recorded time information to a time sheet application page.

10. The non-transitory computer-readable medium of claim 9, including computer-readable instructions stored thereon that, when executed by the processor, cause the processor to:
display the maintained list to a user; and
provide the user with a selectable option to transfer contents of the maintained list to the time sheet application page.

11. The non-transitory computer-readable medium of claim 10, wherein the maintained list displayed to the user includes user-selectable entries, and wherein the non-transitory computer-readable medium includes computer-readable instructions stored thereon that, when executed by the processor, cause the processor to provide user-selected entries to the time sheet application page.

12. The non-transitory computer-readable medium of claim 9, including computer-readable instructions stored thereon that, when executed by the processor, cause the processor to populate a number of fields of a time sheet corresponding to the time sheet application page with content of a number of entries corresponding to the maintained list.

13. A device for time tracking, comprising:
a processor in communication with a memory;
a number of different applications stored on the memory and executable by the processor, the number of different applications including a time tracking component that, when executed by the processor:
displays a time tracker user interface on a currently accessed application page of one of the number of different applications responsive to detecting time tracking context information within the contents of the currently accessed application page, wherein the time tracker user interface indicates a current item associated with the application page and against which time can be logged;
logs time against the current item;
adds the current item and associated logged time information to a maintained list of items against which time has been logged; and
provides the items of the maintained list and associated logged time information to a time sheet application page associated with the time sheet application.

14. The device of claim 13, wherein the number of different applications includes a management application, an email application, and a word processor application.

15. The device of claim 13, wherein the time tracking component includes computer executable instructions that, when executed by the processor, update a content of the time tracker user interface responsive to navigation to a subsequent application page that includes time tracking context information therein
